(19) United States
(12) Patent Application Publication
(10) Pub. No.: US 2006/0271381 A1
(43) Pub. Date: Nov. 30, 2006

(54) Internet-based wedding planning device with multiple-interactive capabilities and method of use

(76) Inventor: Angel Pui, Vancouver (CA)

Correspondence Address: ERIC HANSCOM, 7395 PORTAGE WAY, CARLSBAD, CA, 92011, US

(21) Appl. No.: 11/139,268

(22) Filed: May 27, 2005

(51) Int. Cl. G06Q 99/00

(52) U.S. Cl. 705/1

(57) ABSTRACT

This invention is directed toward an internet-based, interactive wedding planning and management program which allows a wedding group, including the brides, grooms, guest, and wedding planner to interactively plan the wedding, where the bride is the primary account owner and can give each invited guest different usernames and passwords, along with the ability to give administrative access to others, such as a wedding planner, and can set up “user” access limitations which denies information to certain people regarding sensitive features of the wedding. The bride and her administrative users can assign tasks to various guests, which the invention tracks through to their completion. The invention also provides online and interactive features to assist in wedding planning and management, including budget calculators, wedding item organizers, task lists, calendar functions, guest manager functions, a message center & community chat, printing managers, wedding day schedulers, and a wedding checklist.

### CROSS REFERENCE TO RELATED APPLICATIONS

None.

### STATEMENT REGARDING FEDERALLY SPONSORED RESEARCH OR DEVELOPMENT

This invention was not federally sponsored.

### BACKGROUND OF THE INVENTION

This invention is directed toward an internet-based, interactive wedding planning and management program, consisting of software linking two or more networked computers, which allows a wedding group, including the brides, grooms, guest, and wedding planner to interactively plan the wedding, where the bride is the primary account owner and can give each invited guest different usernames and passwords, along with the ability to give administrative access to others, such as a wedding planner, and can set up “user” access limitations which denies information to certain people regarding sensitive features of the wedding. The bride and her administrative users can assign tasks to various guests, which the invention tracks through to their completion. The invention also provides online and interactive features to assist in wedding planning and management, including budget calculators, wedding item organizers, task lists, calendar functions, guest manager functions, a message center & community chat, printing managers, wedding day schedulers, and a wedding checklist.

The history of weddings goes back beyond recorded history, and in the early times did not require much more than a man and a woman who wanted to become married. Indeed, up to the end of the Middle Ages, a wedding was generally a family or village affair which needed the presences of neither witnesses nor the clergy. The presence of a religious representative to perform the ceremony appeared in the 1700's, and can be officially dated to Lord Hardwicke's Marriage Act of 1753, which dictated that all valid marriages in England be held in the Church of England, a Jewish Synagogue or a Quaker Meeting; a marriage held, in other locations were considered invalid.

Over the centuries, as the institution of marriage became more complicated and governed, the planning of weddings also became more important. While royal families often had the predecessors of today's wedding planners at their service while planning the politically important weddings that, in some cases, were intended to forge political alliances or put to rest old international conflicts, there was a general lack of wedding planning assistance for common folk until late in the 1900's.

Despite its relatively recent popularity, the institution of wedding planning has made of for relative infancy compared with other professions with an astronomical growth curve, both in terms of numbers of wedding planners and the multitude of devices and mechanisms by which weddings are planned today. As of the date of this application, more than $100,000,000,000 US is spent per year on wedding in the United States alone, there are now a multitude of schools where prospective wedding planners can learn how to plan weddings, and there was even a recent movie about a wedding planner, titled, not surprisingly, The Wedding Planner.

The internet has become one of the major ways in which wedding planners try to reach clients, establish relationships with vendors, and, in some cases, keep track of certain activities relating to a wedding. The prior art has numerous examples of programs which use the internet to send RSVP's, create WebPages relating to a specific event, and even allowing for the buying and selling of wedding-related items over internet commerce sites. A casual perusal of the internet will find a number of sites which offer “free wedding planning software”, and there are some businesses which purport to offer to arrange and manage an entire wedding through an internet-based software program. There has been, however, a noted lack of a system which allows for the various participants in a wedding to interactively communicate with each other, plan, take action(s), report their progress, be reminded when they are late, and, in general, account for their performances.

These websites are of limited value to someone planning a complex and detail-oriented event, such as a wedding, where there is an ever-changing, dynamic interrelationship between the attendees and the tasks they are assigned to complete in order to create an optimally organized wedding. These websites also do not provide a useful and effective means by which potential guests can receive and transmit information about themselves, the tasks they were assigned, or even their tastes in food and drink. The current invention provides a solution to this problem.

The prior has several examples of attempts to resolve this problem. As mentioned previously, there is a plethora of free downloadable software that may assist a bride in coming up with a wedding budget and performing other basic functions. There is also a pending patent application, US Patent No. 20020156787 to Jameson, which relates to an internet-based system and method for planning and managing an event, a system which could be used to plan and manage a wedding. This system, however, does not allow for the complex communication levels and selectivity proposed by the current invention.

Thus there has existed a long-felt need for an internet-based wedding planning and management invention which allows for complex communication on a number of levels.

The current invention provides just such a solution by having an invention directed to an internet-based, interactive wedding planning and management program which allows a wedding group, including the brides, grooms, guest, and wedding planner to interactively plan the wedding, where the bride is the primary account owner and can give each invited guest different usernames and passwords, along with the ability to give administrative access to others, such as a wedding planner, and can set up “user” access limitations which denies information to certain people regarding sensitive features of the wedding. The bride and her administrative users can assign tasks to various guests, which the invention tracks through to their completion. The invention also provides online and interactive features to assist in wedding planning and management, including budget calculators, wedding item organizers, task lists, calendar functions, guest manager functions, a message center & community chat, printing managers, wedding day schedulers, and a wedding checklist

Through the invention's instant messenger capabilities, various users who log on can tell if another user in online and they can communicate about the wedding. The invention also provides a number of key and unique features, as follows:

A Printing Manager, in which brides and their administrative users can choose from the invention's design templates for many different categories of wedding printing and thereby create Do-It-Yourself invitations and other paper necessities for a wedding by typing in text for them, formatting to achieve the desired appearance, and choosing from different paper stocks and different colors.

A Budget Calculator which allows brides or any other administrative user(s) to add expense items, take estimates, have estimates already programmed into the invention, average estimates, keep track of their estimates, quotes and total expenses. Owners and licensees of the invention can add featured vendors which, in turn, can communicate bids in real time to the brides.

A Wedding Item Organizer which allows brides to keep track of all the tangible items in a wedding and whether the item needs to be rented, returned or purchased, then keeps track of whether these items have been obtained, and sends reminder emails to the person to whom that particular task has been assigned if the task is not completed.

A Task List by which a bride or an administrative user can add new tasks, limit access by users to certain tasks and assignments, and assign said tasks to one or more users within the group, with due dates where the invention tracks progress and sends out reminder notices if needed, optionally, the assignee cannot deny, refuse, or cancel an assigned task. Sequential tasks can also be assigned under the Task List to a sequence of people.

A Calendar Function, which allows the bride and administrative users to create new events and keep track of events and tasks in a calendar format.

A Guest Manager Function, which allows the bride and her administrative users to add guest information, from spreadsheets, word processing files, and standard databases, and invitation details, thereby allow for email communication with that guest, and additionally allow for sorting of guests by a wide range of criteria, and allow for guest to respond by email to the invitation and makes choices of food, etc. The Guest Manager Program also allows the invention to print custom invitations

An online Message Center & Community Chat, in which users can discuss wedding details or decisions online through a forum type message thread, or send each other instant messages, either broadcast, personalized, or limited to a particular group of users, if other users are online at the same time.

A Wedding Day Scheduler, in which the bride or an administrative user can make a schedule for everyone assigned a task on the wedding day and can print it out for each person

A Wedding Checklist, which is an interactive checklist that a bride can add and edit anytime, so that she can check things off as progress is made in getting ready for the wedding.

Because the invention has the organizer (normally the bride), set up her own web site as a URL (Uniform Resource Locator), which consists of a basic identification marker of a line of characters and/or numbers, which can be sent easily through e-mail, the invention has great cost saving potential. Traditionally, a wedding planner or the bride has to telephone every potential guest and work out all the details of the wedding through telephones or regular mail, either option entailing a substantially greater amount of work for the bride or wedding planner than is faced when using email.

### SUMMARY OF THE INVENTION

It is a principal object of the invention to allow a wedding group, including the brides, grooms, bridesmaids, friends, family, and wedding planner to interactively plan the wedding together through the internet, via an URL established by the owner or licensee of the invention.

It is another object of the invention that the bride is allowed to be the primary account owner with the capability of inviting an unlimited number of users onto her wedding group account, where each invited guest has a different username and password.

It is an additional object of the invention that the bride can give administrative access to another account and can set up “user” access limitations which deny information to certain people regarding sensitive features such as budgets, costs, and salaries paid.

It is a further object of the invention that the user status on main menu shows the wedding group's multiple users and their online status as well as showing whether each member of the group is online right now, and if they are not, when they were last online.

It is also an object of this invention that all users from one wedding group can click on each other's name in the user status box and quick message or instant messenger each other whether they are online at the same time.

It is a further object of the invention to provide a Budget Calculator which allows brides or any other administrative user(s) to add expense items and keep track of their estimates, quotes and total expenses.

It is another object of the invention that each expense item is allowed up to three estimates, such that when the bride or other administrative user is ready, he/she can select that estimate as a final expense.

It is an additional object of the invention that the Budget Calculator be able to calculate the average of the estimates, as well as a total of the finalized expenses so even when the bride is in the early stages of planning and has not yet made any final decisions about any potential items with associated costs, he/she can still get an average of the estimates and thereby an idea on how much they should expect to spend on various aspects of the wedding.

It is a further object of the invention that the Budget Calculator offers pre-entered items in all categories so that the most common expense items they will need are already entered, making it easier for them to begin planning the wedding.

It is also an object of this invention that the invention is flexible enough so that an owner of the invention or a licensee is able to add featured vendors that can partner with the owner or licensee and can offer quotes in real-time so brides no longer have to wait for a quote for their wedding—instead it can be obtained directly online and entered into the budget list.

It is a principal object of the invention to allow a bride to enter her desired budget amount and the invention will keep reminding them how far they are from their budget and whether they should spend less up on a certain item as their budget gets depleted.

It is another object of the invention is to provide a Wedding Item Organizer which allows brides to keep track of all the tangible items in a wedding and whether the item needs to be rented, returned or purchased.

It is an additional object of the invention that the Wedding Item Organizer allows a bride to put how many she will need of a certain item and will keep track whether she has enough or if she is missing some of a particular item.

It is a further object of the invention that it keeps track of rental items such that a bride can enter the name of the person who is responsible for that item, when it needs to be returned, and the invention will send an email that person to remind him or her of this task.

It is also an object of this invention to provide a Task List by which a bride can add new tasks and assign said tasks to users within the group.

It is a principal object of the invention that the Task List prevents each task assigned to a certain user to be denied or cancelled as only the bride or administrative user can cancel a task.

It is also an object of this invention that the Task List is designed such that the assignee of a particular task has a specific due date to follow and can put comments on it to keep track of progress and can mark it as “Completed” when done.

It is another object of the invention that the Task List allows for a bride or other administrative user to add a task to the calendar, organize certain tasks as group tasks assigned to a group of more than one user, and allow users to view various tasks on the calendar

It is an additional object of the invention that the Task List has an email reminder feature to remind assignees of a particular task when that task is near its due date

It is an additional object of the invention that if a task is overdue, the invention with cause the bride to be sent a note to remind her that a task is overdue.

It is a further object of the invention that the Task List is not accessible by all users: after bride has added all her tasks, she delegates it out and only those relevant to the tasks can view and work on it.

It is an additional object of the invention that a task can be independent or dependent: independent for one user and to be completed by one user, or delegated to one group of users and complete by that group.

It is a further object of this invention that the Task List be able to assign dependent-series tasks that require one user to finish a first part before the task is then assigned to a second user to be either finished, or worked on further before passing on the task to a third user, eventually ending up with a user which finishes the task, in which case, bride will assign the multiple users as dependent users assigned the same dependant-series task, and give them different due dates, where, once the first user is done, the task will automatically be transferred to second user to continue, etc., until it reaches the final user who is assigned to finish the task.

An additional object of this invention is that some tasks can be hidden from a certain user, so, for example, if a party is to be a secret, the task might be hidden from a certain user.

It is also an object of this invention that one, some, or all users can create events keep them hidden from even the bride or an admin user (such as a bachelorette party).

It is a further object of the invention to provide a Calendar Function, which allows the bride and users to create new events and keep track of events and tasks in a calendar format.

It is an additional object of the invention to create a Guest Manager Function, which allows the bride and her administrative users to add guest information and invitation details.

It is a further object of the invention that after each guest's information is entered, if the guest has an email address, the bride or an administrative user can send out email invitations or messages to the guest.

An additional object of the invention is to allow guests to be organized and sorted out by their table number, by name, by residential information, by age, by sex, by their group (friends, work friends, family, etc), or by their food choices.

It is a further object of this invention that guests can RSVP to the invitation online through a Guest RSVP service, by which guests can respond to the invitation and choose their choice of food or other choices available to them.

It is also an object of this invention that the bride or an administrative user can import guest names from any spreadsheet or database type of program for easy insertion into the invention.

It is an additional object of the invention that a bride or an administrative user can customize invitation printing through a Guest Manager Program, which can customize invitation printing by simply importing each guest's name, thereby avoiding the common practice of writing the envelopes by hand to each guest.

It is a further object of the invention to provide an online forum for a Message Center & Community Chat, in which users can discuss important wedding details or decisions online through a forum type message thread, or send each other instant messages if other users are online at the same time.

It is also an object of this invention that messages can be broadcasted to the entire user group, a particular group, to the entire user group with the exception of a particular group from which the message is hidden, or specifically to just one person.

It is a further object of the invention to provide a quick drag-and-drop Printing Manager, in which brides and their administrative users can choose from the invention's design templates for many different categories of wedding printing and thereby create Do-It-Yourself invitations and other paper necessities for a wedding by typing in text for them, formatting to achieve the desired appearance, and choosing from different paper stocks and different colors.

It is an additional object of the invention that an owner of licensee of the invention be able to custom print each card according to the bride's specifications with each guest's name and address

It is also an object of this invention to provide a Wedding Day Scheduler, in which the bride or an administrative user can make a schedule for everyone assigned a task on the wedding day and can print it out for each person

It is a final object of this invention to provide a Wedding Checklist, which is an interactive checklist that a bride can add and edit anytime, so that she can check things off as progress is made in getting ready for the wedding.

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention. Accordingly, the present invention is not limited to the specific embodiments described above, but rather, is defined by the scope of the claims as they appear herein.

### DETAILED DESCRIPTION OF THE INVENTION

an invention directed to an internet-based, interactive wedding planning and management program which allows a wedding group, including the brides, grooms, guest, and wedding planner to interactively plan the wedding, where the bride is the primary account owner and can give each invited guest different usernames and passwords, along with the ability to give administrative access to others, such as a wedding planner, and can set up “user” access limitations which denies information to certain people regarding sensitive features of the wedding. The bride and her administrative users can assign tasks to various guests, which the invention tracks through to their completion. The invention also provides online and interactive features to assist in wedding planning and management, including budget calculators, wedding item organizers, task lists, calendar functions, guest manager functions, a message center & community chat, printing managers, wedding day schedulers, and a wedding checklist

Through the invention's instant messenger capabilities, various users who log on can tell if another user in online and they can communicate about the wedding. The invention also provides a number of key and unique features, each of which can be accessed through the website upon which the invention resides:

A Printing Manager, in which brides and their administrative users can choose from the invention's design templates for many different categories of wedding printing and thereby create Do-It-Yourself invitations and other paper necessities for a wedding by typing in text for them, formatting to achieve the desired appearance, and choosing from different paper stocks and different colors.

a URL selected and established by the user of the invention in conjunction with the owner or licensee of the invention,

an internet-based software program that allows a wedding group, including brides, grooms, bridesmaids, friends, family, and wedding planners to interactively plan the wedding together through the internet, where

the internet-based software program has embedded into it one or more operably-coupled modules, where each module is directed to manage a different aspect of a wedding, and where the bride is the primary account owner with the capability of inviting an unlimited number of guests onto her wedding group account, where each guest has a different username and password, and where, each guest can be categorized into one or more groups, and where,

the bride can give administrative access to another account, thereby creating one or more administrative users, and can set up access limitations for one or more guests which denies information to certain guests regarding sensitive features such as budgets, costs, and salaries paid, and where,

the user status on main menu shows which guests are online at any given time, as well as showing whether each member of a particular group is online right now, and if they are not, when they were last online, and where,

all users from one group can click on each other's name in a user status box and send a quick message or an instant messenger to other members of that particular group when they are online at the same time, and,

A Budget Calculator which allows brides or any other administrative user(s) to add expense items, take estimates, have estimates already programmed into the invention, average estimates, keep track of their estimates, quotes and total expenses. Owners and licensees of the invention can add featured vendors which, in turn, can communicate bids in real time to the brides. Each of the expense items is allowed up to three estimates, such that when the bride or another administrative user is ready, he or she can select that estimate as a final expense. The average of the estimates can be calculated, as well as a total of the finalized expenses so even when the bride is in the early stages of planning and has not yet made any final decisions about any potential items with associated costs, she can still get an average of the estimates and thereby an idea on how much she should expect to spend on various aspects of the wedding. The Budget Calculator also allows for one or more common expenses to be pre-entered by the invention through its owner and/or licensee, such that the most common expense items needed at most weddings will already be entered in a bride's program, making it easier for her to begin planning the wedding. Another function of the Budget Calculator allows a bride to enter her desired budget amount and the program will keep reminding the bride how far she is above or below her budget and whether she should spend less up on a certain item as her budget gets depleted.

A Wedding Item Organizer which allows brides to keep track of all the tangible items in a wedding and whether the item needs to be rented, returned or purchased, then keeps track of whether these items have been obtained, and sends reminder emails to the person to whom that particular task has been assigned if the task is not completed. The Wedding Item Organizer also allows a bride to enter into the program how many she will need of a certain item and will keep track whether she has enough or if she is missing some of a particular item. The Wedding Item Organizer also has the capability to keep track of rental items such that a bride can enter the name of the person who is responsible for that item, when it needs to be returned, and the invention will send an email that person to remind him or her of this task, as well as sending the bride or another designated administrative user a notification of any tardiness by assignees or when the assignee has completed the task.

A Task List by which a bride or an administrative user can add new tasks, limit access by users to certain tasks and assignments, and assign said tasks to one or more users within the group, with due dates where the invention tracks progress and sends out reminder notices if needed, optionally, the assignee cannot deny, refuse, or cancel an assigned task. Sequential tasks can also be assigned under the Task List to a sequence of people. The Task List prevents each task assigned to a certain guest to be denied or cancelled such that only the bride or one of her administrative users can cancel a task. The bride or an administrative user can log onto the Task List to enter into the program that the assignee of a particular task has a specific due date to follow and can put comments on it to keep track of progress and can mark it as “Completed” when done. The Task List also allows for a bride or other administrative user to add a task to a calendar function within the Task List, then organize certain tasks as group tasks assigned to a group of more than one user, and allow guests to view various tasks on the calendar. An additional function of the Task List is an email reminder feature which reminds assignees of a particular task when that task is near its due date, such that if a task is overdue, the invention will cause the bride to be sent a note to remind her that a task is overdue, and will also send her a message when the task has been completed. The Task List is not accessible by all users, such that after a bride has added all her tasks, she can delegate the tasks out and only those guests relevant to the tasks can view the task and work on it. Brides and/or their administrative users can use the Task List to designate that a task can be independent or dependent, or even sequentially dependant. For example, a task could be independent for one guest and to be completed by that same guest, or delegated to one group of guests and completed by that group. Alternatively, the bride or an administrative user can assign dependent-sequential tasks that require one user to finish a first part before the task is then assigned to a second user to be either finished, or worked on further before passing on the task to a third user, eventually ending up with a user which finishes the task. In the case of dependent-sequential tasks, the bride will assign the multiple users as dependent users assigned the same dependant-sequential task, and give them different due dates, where, once the first user is done, the task will automatically be transferred to second user to continue, etc., until it reaches the final user who is assigned to finish the task. The Task Manager module also allows that some tasks can be hidden from a certain user, so, for example, if a party is to be a secret, the task might be hidden from a certain user, such as the bride, for whom the surprise is intended. This function even allows one, some, or all users to create events and keep them hidden from even the bride or an administrative user (such as a bachelorette party).

A Calendar Function, which allows the bride and administrative users to create new events and keep track of events and tasks in a calendar format.

A Guest Manager Function, which allows the bride and her administrative users to add guest information and invitation details, from spreadsheets, word processing files, and standard databases, and invitation details, thereby allow for email communication with that guest, and additionally allow for sorting of guests by a wide range of criteria including table number, by name, by residential information, by age, by sex, by their group (friends, work friends, family, etc), or by their food choices, and allow for guests to respond or RSVP to the invitation online through a Guest RSVP service by email to the invitation and make choices of food, etc. The Guest Manager module allows the bride or an administrative user can import guest names from any spreadsheet or database type of program for easy insertion into the program, and customize invitation printing through by simply importing each guest's name, thereby avoiding the common practice of writing the envelopes by hand to each guest.

A Printing Manager, operated as a drag-and-drop interface, in which brides and their administrative users can choose from the invention's design templates for many different categories of wedding printing and thereby create Do-It-Yourself invitations and other paper necessities for a wedding by typing in text for them, formatting to achieve the desired appearance, and choosing from different paper stocks and different colors. The Printing Manager is specifically designed such that the owner or licensee of the invention is able to custom print each card according to the bride's specifications with each guest's name and address, thereby avoiding the normal hassle of having to hand write each invitation. The Printing Manager also has a flexible aspect that allows an owner of the invention or a licensee of the invention to add one or more featured vendors that can partner with the owner or licensee and can offer quotes in real-time so brides no longer have to wait for a quote for their wedding, but rather instead obtain the quote directly online and enter it onto the budget list.

An online Message Center & Community Chat, in which users can discuss wedding details or decisions online through a forum type message thread, or send each other instant messages if other guests are online at the same time. The messages can either broadcast, to the entire user group, a particular group, to the entire user group with the exception of a particular group from which the message is hidden, or specifically to just one person.

A Wedding Day Scheduler, in which the bride or an administrative user can make a schedule for everyone assigned a task on the wedding day and can print it out for each person

A Wedding Checklist, which is an interactive checklist that a bride can add and edit anytime, so that she can check things off as progress is made in getting ready for the wedding.

What I claim is:

1. A program for planning and managing a wedding, comprising:
a URL selected and established by the user of the invention in conjunction with the owner or licensee of the invention,
an internet-based software program that allows a wedding group, including brides, grooms, bridesmaids, friends, family, and wedding planners to interactively plan the wedding together through the internet, where
the internet-based software program has embedded into it one or more operably-coupled modules, where each module is directed to manage a different aspect of a wedding, and where
the bride is the primary account owner with the capability of inviting an unlimited number of guests onto her wedding group account, where each guest has a different username and password, and where, each guest can be categorized into one or more groups, and where,
the bride can give administrative access to another account, thereby creating one or more administrative users, and can set up access limitations for one or more guests which denies information to certain guests regarding sensitive features such as budgets, costs, and salaries paid, and where,
the user status on main menu shows which guests are online at any given time, as well as showing whether each member of a particular group is online right now, and if they are not, when they were last online, and where,
all users from one group can click on each other's name in a user status box and send a quick message or an instant messenger to other members of that particular group when they are online at the same time, and,
a Printing Manager, operated as a drag-and-drop interface, in which brides and their administrative users can choose from the invention's design templates for many different categories of wedding printing and thereby create Do-It-Yourself invitations and other paper necessities for a wedding by typing in text for them, formatting to achieve the desired appearance, and choosing from different paper stocks and different colors, and where,
an owner or licensee of the invention is able to custom print each card according to the bride's specifications with each guest's name and address.

2. The program of claim 1, additionally comprising:
a Budget Calculator which allows brides or any other administrative user(s) to add expense items and keep track of one or more estimates, quotes and total expenses, and where,
each of the one or more expense items is allowed up to three estimates, such that when the bride or another administrative user is ready, he or she can select that estimate as a final expense, and where,
the average of the estimates can be calculated, as well as a total of the finalized expenses so even when the bride is in the early stages of planning and has not yet made any final decisions about any potential items with associated costs, he/she can still get an average of the estimates and thereby an idea on how much they should expect to spend on various aspects of the wedding, and where,
one or more pre-entered items in all categories can be entered so that the most common expense items needed at most weddings will already be entered in a bride's program, making it easier for her to begin planning the wedding, and where,
the program allows a bride to enter her desired budget amount and the program will keep reminding the bride how far she is above or below her budget and whether she should spend less up on a certain item as her budget gets depleted.

3. The program of claim 2, additionally comprising:
a flexible aspect that allows an owner of the invention or a licensee of the invention to add one or more featured vendors that can partner with the owner or licensee and can offer quotes in real-time so brides no longer have to wait for a quote for their wedding, but rather instead obtain the quote directly online and enter it onto the budget list.

4. The program of claim 3, additionally comprising:
a Wedding Item Organizer which allows brides to keep track of all the tangible items in a wedding and whether the item needs to be rented, returned or purchased, where,
the Wedding Item Organizer allows a bride to enter into the program how many she will need of a certain item and will keep track whether she has enough or if she is missing some of a particular item, and where,
the Wedding Item Organizer keeps track of rental items such that a bride can enter the name of the person who is responsible for that item, when it needs to be returned, and the invention will send an email that person to remind him or her of this task.

5. The program of claim 4, additionally comprising:
a Task List by which a bride can add one of more new tasks and assign said tasks to guests within the group, and where,
the Task List prevents each task assigned to a certain guest to be denied or cancelled such that only the bride or one of her administrative users can cancel a task, and where,
the Task List allows the bride or an administrative user to enter into the program that the assignee of a particular task has a specific due date to follow and can put comments on it to keep track of progress and can mark it as “Completed” when done, and where,
the Task List allows for a bride or other administrative user to add a task to a calendar function within the Task List, then organize certain tasks as group tasks assigned to a group of more than one user, and allow guests to view various tasks on the calendar, and where,
the Task List has an email reminder feature which reminds assignees of a particular task when that task is near its due date, such that if a task is overdue, the invention will cause the bride to be sent a note to remind her that a task is overdue, and where,
the Task List is not accessible by all users, such that after a bride has added all her tasks, she can delegates said tasks out and only those guests relevant to the tasks can view the task and work on it, and where,
the Task List allows the bride or administrative user to designate that a task can be independent or dependent: independent for one guest and to be completed by that same guest, or delegated to one group of guests and complete by that group, and where,
the Task List allows the bride or an administrative user to assign dependent-series tasks that require one user to finish a first part before the task is then assigned to a second user to be either finished, or worked on further before passing on the task to a third user, eventually ending up with a user which finishes the task, in which case, bride will assign the multiple users as dependent users assigned the same dependant-series task, and give them different due dates, where, once the first user is done, the task will automatically be transferred to second user to continue, etc., until it reaches the final user who is assigned to finish the task.

6. The program of claim 5, additionally comprising,
a software function that allows that some tasks can be hidden from a certain user, so, for example, if a party is to be a secret, the task might be hidden from a certain user, such as the bride, for whom the surprise is intended, and where,
one, some, or all users can create events keep them hidden from even the bride or an admin user (such as a bachelorette party).

7. The program of claim 6, additionally comprising,
a Calendar Function, which allows the bride and administrative users to create new events and keep track of events and tasks in a calendar format.

8. The program of claim 7, additionally comprising,
a Guest Manager Function, created in such a way that allows the bride and her administrative users to add guest information and invitation details, and where,
after each guest's information is entered, if the guest has an email address, the bride or an administrative user can send out email invitations or messages to the guest, and where,
guests can be organized and sorted out by their table number, by name, by residential information, by age, by sex, by their group (friends, work friends, family, etc.), or by their food choices, and where,
guests can RSVP to the invitation online through a Guest RSVP service, by which guests can respond to the invitation and choose their choice of food or other choices available to them, and where,
the bride or an administrative user can import guest names from any spreadsheet or database type of program for easy insertion into the program, and where,
a bride or an administrative user can customize invitation printing through by simply importing each guest's name, thereby avoiding the common practice of writing the envelopes by hand to each guest.

9. The program of claim 8, additionally comprising,
an online forum for a Message Center & Community Chat, in which guests can discuss important wedding details or decisions online through a forum type message thread, or send each other instant messages if other guests are online at the same time.

10. The program of claim 9, where, additionally,
said messages can be broadcasted to the entire user group, a particular group, to the entire user group with the exception of a particular group from which the message is hidden, or specifically to just one person.

11. The program of claim 10, additionally comprising,
a Wedding Day Scheduler, in which the bride or an administrative user can make a schedule for everyone assigned a task on the wedding day and can print it out for each person.

12. The program of claim 11, additionally comprising,
a Wedding Checklist, which is an interactive checklist that a bride can add and edit anytime, so that she can check things off as progress is made in getting ready for the wedding.

13. A method of planning and managing a wedding, comprising,
combining a URL selected and established by the user of the invention in conjunction with the owner or licensee of the invention with a number of other features, including,
an internet-based software program that allows a wedding group, including brides, grooms, bridesmaids, friends, family, and wedding planners to interactively plan the wedding together through the internet, where
the internet-based software program has embedded into it one or more operably-coupled modules, where each module is directed to manage a different aspect of a wedding, and where
the bride is the primary account owner with the capability of inviting an unlimited number of guests onto her wedding group account, where each guest has a different username and password, and where, each guest can be categorized into one or more groups, and where,
the bride can give administrative access to another account, thereby creating one or more administrative users, and can set up access limitations for one or more guests which denies information to certain guests regarding sensitive features such as budgets, costs, and salaries paid, and where,
the user status on main menu shows which guests are online at any given time, as well as showing whether each member of a particular group is online right now, and if they are not, when they were last online, and where,
all users from one group can click on each other's name in a user status box and send a quick message or an instant messenger to other members of that particular group when they are online at the same time, and,
a Printing Manager, operated as a drag-and-drop interface, in which brides and their administrative users can choose from the invention's design templates for many different categories of wedding printing and thereby create Do-It-Yourself invitations and other paper necessities for a wedding by typing in text for them, formatting to achieve the desired appearance, and choosing from different paper stocks and different colors, where, an owner or licensee of the invention is able to custom print each card according to the bride's specifications with each guest's name and address.

14. The method of claim 13, additionally comprising:
a Budget Calculator which allows brides or any other administrative user(s) to add expense items and keep track of one or more estimates, quotes and total expenses, and where,
each of the one or more expense items is allowed up to three estimates, such that when the bride or another administrative user is ready, he or she can select that estimate as a final expense, and where,
the average of the estimates can be calculated, as well as a total of the finalized expenses so even when the bride is in the early stages of planning and has not yet made any final decisions about any potential items with associated costs, he/she can still get an average of the estimates and thereby an idea on how much they should expect to spend on various aspects of the wedding, and where,
one or more pre-entered items in all categories can be entered so that the most common expense items needed at most weddings will already be entered in a bride's program, making it easier for her to begin planning the wedding, and where,
the program allows a bride to enter her desired budget amount and the program will keep reminding the bride how far she is above or below her budget and whether she should spend less up on a certain item as her budget gets depleted, and,
a flexible aspect that allows an owner of the invention or a licensee of the invention to add one or more featured vendors that can partner with the owner or licensee and can offer quotes in real-time so brides no longer have to wait for a quote for their wedding, but rather instead obtain the quote directly online and enter it onto the budget list, and,
a Wedding Item Organizer which allows brides to keep track of all the tangible items in a wedding and whether the item needs to be rented, returned or purchased, where,
the Wedding Item Organizer allows a bride to enter into the program how many she will need of a certain item and will keep track whether she has enough or if she is missing some of a particular item, and where,
the Wedding Item Organizer keeps track of rental items such that a bride can enter the name of the person who is responsible for that item, when it needs to be returned, and the invention will send an email that person to remind him or her of this task.

15. The method of claim 14, additionally comprising:
a Task List by which a bride can add one of more new tasks and assign said tasks to guests within the group, and where,
the Task List prevents each task assigned to a certain guest to be denied or cancelled such that only the bride or one of her administrative users can cancel a task, and where,
the Task List allows the bride or an administrative user to enter into the program that the assignee of a particular task has a specific due date to follow and can put comments on it to keep track of progress and can mark it as “Completed” when done, and where,
the Task List allows for a bride or other administrative user to add a task to a calendar function within the Task List, then organize certain tasks as group tasks assigned to a group of more than one user, and allow guests to view various tasks on the calendar, and where,
the Task List has an email reminder feature which reminds assignees of a particular task when that task is near its due date, such that if a task is overdue, the invention will cause the bride to be sent a note to remind her that a task is overdue, and where,
the Task List is not accessible by all users, such that after a bride has added all her tasks, she can delegates said tasks out and only those guests relevant to the tasks can view the task and work on it, and where,
the Task List allows the bride or administrative user to designate that a task can be independent or dependent: independent for one guest and to be completed by that same guest, or delegated to one group of guests and complete by that group, and where,
the Task List allows the bride or an administrative user to assign dependent-series tasks that require one user to finish a first part before the task is then assigned to a second user to be either finished, or worked on further before passing on the task to a third user, eventually ending up with a user which finishes the task, in which case, bride will assign the multiple users as dependent users assigned the same dependant-series task, and give them different due dates, where, once the first user is done, the task will automatically be transferred to second user to continue, etc., until it reaches the final user who is assigned to finish the task, and,
a software function that allows that some tasks can be hidden from a certain user, so, for example, if a party is to be a secret, the task might be hidden from a certain user, such as the bride, for whom the surprise is intended, and where,
one, some, or all users can create events keep them hidden from even the bride or an admin user (such as a bachelorette party).

16. The program of claim 15, additionally comprising,
a Calendar Function, which allows the bride and administrative users to create new events and keep track of events and tasks in a calendar format, and,
a Guest Manager Function, created in such a way that allows the bride and her administrative users to add guest information and invitation details, and where,
after each guest's information is entered, if the guest has an email address, the bride or an administrative user can send out email invitations or messages to the guest, and where,
guests can be organized and sorted out by their table number, by name, by residential information, by age, by sex, by their group (friends, work friends, family, etc.), or by their food choices, and where,
guests can RSVP to the invitation online through a Guest RSVP service, by which guests can respond to the invitation and choose their choice of food or other choices available to them, and where,
the bride or an administrative user can import guest names from any spreadsheet or database type of program for easy insertion into the program, and where,
a bride or an administrative user can customize invitation printing through by simply importing each guest's name, thereby avoiding the common practice of writing the envelopes by hand to each guest, and,
an online forum for a Message Center & Community Chat, in which guests can discuss important wedding details or decisions online through a forum type message thread, or send each other instant messages if other guests are online at the same time, and where,
said messages can be broadcasted to the entire user group, a particular group, to the entire user group with the exception of a particular group from which the message is hidden, or specifically to just one person.

17. The method of claim 16, additionally comprising,
a Wedding Day Scheduler, in which the bride or an administrative user can make a schedule for everyone assigned a task on the wedding day and can print it out for each person.

18. The program of claim 17, additionally comprising,
a Wedding Checklist, which is an interactive checklist that a bride can add and edit anytime, so that she can check things off as progress is made in getting ready for the wedding.

19. A program for planning and managing a wedding, consisting of:
A program for planning and managing a wedding, comprising:
a URL selected and established by the user of the invention in conjunction with the owner or licensee of the invention,
an internet-based software program that allows a wedding group, including brides, grooms, bridesmaids, friends, family, and wedding planners to interactively plan the wedding together through the internet, where
the internet-based software program has embedded into it one or more operably-coupled modules, where each module is directed to manage a different aspect of a wedding, and where
the bride is the primary account owner with the capability of inviting an unlimited number of guests onto her wedding group account, where each guest has a different username and password, and where, each guest can be categorized into one or more groups, and where,
the bride can give administrative access to another account, thereby creating one or more administrative users, and can set up access limitations for one or more guests which denies information to certain guests regarding sensitive features such as budgets, costs, and salaries paid, and where,
the user status on main menu shows which guests are online at any given time, as well as showing whether each member of a particular group is online right now, and if they are not, when they were last online, and where,
all users from one group can click on each other's name in a user status box and send a quick message or an instant messenger to other members of that particular group when they are online at the same time, and,
a Budget Calculator which allows brides or any other administrative user(s) to add expense items and keep track of one or more estimates, quotes and total expenses, and where,
each of the one or more expense items is allowed up to three estimates, such that when the bride or another administrative user is ready, he or she can select that estimate as a final expense, and where,
the average of the estimates can be calculated, as well as a total of the finalized expenses so even when the bride is in the early stages of planning and has not yet made any final decisions about any potential items with associated costs, he/she can still get an average of the estimates and thereby an idea on how much they should expect to spend on various aspects of the wedding, and where,
one or more pre-entered items in all categories can be entered so that the most common expense items needed at most weddings will already be entered in a bride's program, making it easier for her to begin planning the wedding, and where,
the program allows a bride to enter her desired budget amount and the program will keep reminding the bride how far she is above or below her budget and whether she should spend less up on a certain item as her budget gets depleted, and,
a flexible aspect that allows an owner of the invention or a licensee of the invention to add one or more featured vendors that can partner with the owner or licensee and can offer quotes in real-time so brides no longer have to wait for a quote for their wedding, but rather instead obtain the quote directly online and enter it onto the budget list, and,
a Wedding Item Organizer which allows brides to keep track of all the tangible items in a wedding and whether the item needs to be rented, returned or purchased, where,
the Wedding Item Organizer allows a bride to enter into the program how many she will need of a certain item and will keep track whether she has enough or if she is missing some of a particular item, and where,
the Wedding Item Organizer keeps track of rental items such that a bride can enter the name of the person who is responsible for that item, when it needs to be returned, and the invention will send an email that person to remind him or her of this task, and,
a Task List by which a bride can add one of more new tasks and assign said tasks to guests within the group, and where,
the Task List prevents each task assigned to a certain guest to be denied or cancelled such that only the bride or one of her administrative users can cancel a task, and where,
the Task List allows the bride or an administrative user to enter into the program that the assignee of a particular task has a specific due date to follow and can put comments on it to keep track of progress and can mark it as “Completed” when done, and where,
the Task List allows for a bride or other administrative user to add a task to a calendar function within the Task List, then organize certain tasks as group tasks assigned to a group of more than one user, and allow guests to view various tasks on the calendar, and where,
the Task List has an email reminder feature which reminds assignees of a particular task when that task is near its due date, such that if a task is overdue, the invention will cause the bride to be sent a note to remind her that a task is overdue, and where,
the Task List is not accessible by all users, such that after a bride has added all her tasks, she can delegates said tasks out and only those guests relevant to the tasks can view the task and work on it, and where,
the Task List allows the bride or administrative user to designate that a task can be independent or dependent: independent for one guest and to be completed by that same guest, or delegated to one group of guests and complete by that group, and where,
the Task List allows the bride or an administrative user to assign dependent-series tasks that require one user to finish a first part before the task is then assigned to a second user to be either finished, or worked on further before passing on the task to a third user, eventually ending up with a user which finishes the task, in which case, bride will assign the multiple users as dependent users assigned the same dependant-series task, and give them different due dates, where, once the first user is done, the task will automatically be transferred to second user to continue, etc., until it reaches the final user who is assigned to finish the task, and,
a software function that allows that some tasks can be hidden from a certain user, so, for example, if a party is to be a secret, the task might be hidden from a certain user, such as the bride, for whom the surprise is intended, and where,
one, some, or all users can create events keep them hidden from even the bride or an admin user (such as a bachelorette party), and,
a Calendar Function, which allows the bride and administrative users to create new events and keep track of events and tasks in a calendar format, and,
a Guest Manager Function, created in such a way that allows the bride and her administrative users to add guest information and invitation details, and where,
after each guest's information is entered, if the guest has an email address, the bride or an administrative user can send out email invitations or messages to the guest, and where,
guests can be organized and sorted out by their table number, by name, by residential information, by age, by sex, by their group (friends, work friends, family, etc.), or by their food choices, and where,
guests can RSVP to the invitation online through a Guest RSVP service, by which guests can respond to the invitation and choose their choice of food or other choices available to them, and where,
the bride or an administrative user can import guest names from any spreadsheet or database type of program for easy insertion into the program, and where,
a bride or an administrative user can customize invitation printing through by simply importing each guest's name, thereby avoiding the common practice of writing the envelopes by hand to each guest, and,
an online forum for a Message Center & Community Chat, in which guests can discuss important wedding details or decisions online through a forum type message thread, or send each other instant messages if other guests are online at the same time, and where,
said messages can be broadcasted to the entire user group, a particular group, to the entire user group with the exception of a particular group from which the message is hidden, or specifically to just one person, and,
a Printing Manager, operated as a drag-and-drop interface, in which brides and their administrative users can choose from the invention's design templates for many different categories of wedding printing and thereby create Do-It-Yourself invitations and other paper necessities for a wedding by typing in text for them, formatting to achieve the desired appearance, and choosing from different paper stocks and different colors, and where, an owner or licensee of the invention is able to custom print each card according to the bride's specifications with each guest's name and address, and,
a Wedding Day Scheduler, in which the bride or an administrative user can make a schedule for everyone assigned a task on the wedding day and can print it out for each person, and,
a Wedding Checklist, which is an interactive checklist that a bride can add and edit anytime, so that she can check things off as progress is made in getting ready for the wedding.
